(19) United States
(12) Patent Application Publication
(10) Pub. No.: US 2005/0166031 A1
(43) Pub. Date: Jul. 28, 2005

(54) Memory access register file

(76) Inventors: Anders Per Holmberg, Stockholm (SE); Lars Winberg, Stockholm (SE); Joachim Oscar Karl Strombergson, Goteborg (SE)

Correspondence Address: ERICSSON INC., 6300 LEGACY DRIVE, M/S EVR C11, PLANO, TX, 75024, US

(21) Appl. No.: 10/511,877

(22) PCT Filed: Apr. 26, 2002
(86) PCT No.: PCT/SE02/00835

(51) Int. Cl. G06F 12/00

(52) U.S. Cl. 711/200

(57) ABSTRACT

The general idea according to the invention is to introduce a special purpose register file (34) adapted for holding memory address calculation information received from memory (50, 70) and to provide one or more dedicated interfaces (73, 74) for allowing efficient transfer of memory address calculation information in relation to the special-purpose register file. The special-purpose register file (34) is preferably connected to at least one functional processor unit (42), which is operable for determining a memory address based on memory address calculation information received from the special-purpose register file (34). Once the memory address has been determined, the corresponding memory access can be effectuated.

### TECHNICAL FIELD OF THE INVENTION

The present invention generally relates to processor technology and computer systems, and more particularly to a hardware design for handling memory address calculation information in such systems.

### BACKGROUND OF THE INVENTION

With the ever-increasing demand for faster and more effective computer systems naturally comes the need for faster and more sophisticated electronic components. The computer industry has been extremely successful in developing new and faster processors. The processing speed of state-of-the-art processors has increased at a spectacular rate over the past decades. However, one of the major bottlenecks in computer systems is the access to the memory system, and the handling of memory address calculation information. This problem is particularly pronounced in applications with implicit memory address information, requiring sequenced memory address calculation. A sequenced memory address calculation based on implicit memory address information generally requires several clock cycles before the actual data corresponding to the memory address can be read.

In systems using dynamic linking, for example systems with dynamically linked code that can be reconfigured during operation, memory addresses are generally determined by means of several table look-ups in different tables. This typically means that an initial memory address calculation information may contain a pointer to a first look-up table, and that table holds a pointer to another table, which in turn holds a pointer to a further table and so on until the target address can be retrieved from a final table. With several look-up tables, a lot of memory address calculation information must be read and processed before the target address can be retrieved and the corresponding data accessed.

Another situation where the handling of memory address calculation information really becomes a major bottleneck is when a CISC (Complex Instruction Set Computer) instruction set is emulated on a RISC (Reduced Instruction Set Computer) or VLIW (Very Long Instruction Word) processor. In such a case, the complex CISC memory operations can not be mapped directly to a corresponding RISC instruction or to an operation in a VLIW instruction. Instead, each complex memory operation is mapped to a sequence of instructions that performs memory address calculations, memory mapping and so forth. Several problems arise with the emulation, including low performance due to a high instruction count, high register pressure since many registers are used for storing temporary results, and additional pressure on load/store units in the processor for handling address translation table lookups.

A standard solution to the problem of handling implicit memory address information, in particular during instruction emulation, is to rely as much as possible on software optimizations for reducing the overhead caused by the emulation. But software solutions can only reduce the performance penalty, not solve it. There will consequently still be a large amount of memory operations to be performed. The many memory operations may be performed either serially or handled in parallel with other instructions by making the instruction wider. However, serial performance requires more clock cycles, whereas a wider instruction will give a high pressure on the register files, requiring more register ports and more execution units. Parallel performance thus gives a larger and more complex processor design but also a lower effective clock frequency.

An alternative solution is to devise a special-purpose instruction set in the target architecture. This instruction set can be provided with operations that perform the same complex address calculations that are performed by the emulated instruction set. Since the complex address calculations are intact, there is less opportunity for optimizations when mapping the memory access instructions into a special purpose native instruction. Although the number of instructions required for emulation of complex addressing modes can be reduced, this approach thus gives less flexibility.

Even with special-purpose instructions, there will normally be extra loads for loading the implicit memory access information. Emulators usually keep these in memory and cache them as any other data. This gives additional memory reads for each memory access in the emulated instruction stream, and thus requires a larger data cache with more associativity. This is generally not an option in modern processors that are optimized for highest possible clock frequency. In addition, implicit memory access information typically does not fit directly in normal-sized words. The common way of handling this problem is to use several instructions for reading the information from memory, which in effect means that additional instructions have to be executed.

U.S. Pat. No. 5,696,957 describes an integrated unit adapted for executing a plurality of programs, where data stored in a register set must be replaced each time a program is changed. The integrated unit has a central processing unit (CPU) for executing the programs and a register set for storing crate required for executing a program in the CPU. In addition, a register-file RAM is coupled to the CPU for storing at least the same data as that stored in the register set. The stored data of the register-file RAM may then be supplied to the register set when a program is replaced.

### SUMMARY OF THE INVENTION

The present invention overcomes these and other drawbacks of the prior art arrangements.

It is a general object of the present invention to improve the performance of a computer system.

It is another object of the invention to increase the effective memory access bandwidth in the system.

Yet another object of the invention is to provide an efficient memory access system.

Still another object of the invention is to provide a hardware design for effectively handling memory address calculation information in a computer system.

It is also an object of the invention to minimize interconnect delays in silicon implementations.

These and other objects are met by the invention as defined by the accompanying patent claims.

The general idea according to the invention is to introduce a special-purpose register file adapted for holding memory address calculation information received from memory and to provide one or more dedicated interfaces for allowing efficient transfer of memory address calculation information in relation to the special-purpose register file. The special-purpose register file is preferably connected to at least one functional processor unit, which is operable for determining a memory address based on memory address calculation information received from the special-purpose register file. Once the memory address has been determined, the corresponding memory access can be effectuated.

For efficient loading of memory address calculation information, such as implicit memory access information, into the special-purpose register file, the special register file is preferably provided with a dedicated interface towards memory.

For efficient transfer of the memory address calculation information from the special-purpose register file to the relevant functional processor unit or units, the special register file is preferably provided with a dedicated interface towards the functional processor unit or units.

By having dedicated data paths to and/or from the special-purpose register file, memory address calculation information can be transferred in parallel with other data that are transferred to and/or from the general register file of the computer system. This results in a considerable increase of the overall system efficiency.

The special-purpose register file and its dedicated interface or interfaces do not have to use the same width as the normal registers and data paths in the system. Instead, as the address calculation information is typically wider, it is beneficial to utilize width-adapted data paths for transferring the address calculation information to avoid multi-cycle transfers.

In a preferred embodiment of the invention, the overall memory system includes a dedicated cache adapted for the memory address calculation information, and the special-purpose register file is preferably loaded directly from the dedicated cache via a dedicated interface between the cache and the special register file.

It has turned out to be advantageous to use special-purpose instructions for loading the special-purpose register file. In similarity, special-purpose instructions may also be used for performing the actual address calculations based on the address calculation information.

The invention offers the following advantages:
Improved general system performance;
Increased memory access bandwidth;
Efficient handling of memory address calculation information; and
Optimized silicon implementations.
   Other advantages offered by the present invention will be appreciated upon reading of the below description of the embodiments of the invention.

### BRIEF DESCRIPTION OF THE DRAWINGS

The invention, together with further objects and advantages thereof, will be best understood by reference to the following description taken together with the accompanying drawings, in which:

FIG. 1 is a schematic block diagram of a computer system in which the present invention can be implemented;

FIG. 2 is a schematic block diagram illustrating relevant parts of a computer system according to an embodiment of the invention;

FIG. 3 is a schematic block diagram illustrating relevant parts of a computer system according to another embodiment of the present invention;

FIG. 4 is a schematic block diagram illustrating parts of a computer system according to a further embodiment of the present invention;

FIG. 5 is a schematic block diagram illustrating relevant parts of a computer system according to yet another embodiment of the present invention;

FIG. 6 is a schematic principle diagram illustrating three memory reads in a prior art computer system;

FIG. 7 is a schematic principle diagram illustrating three memory reads in a computer system according to an embodiment of the present invention;

FIG. 8 is a schematic principle diagram illustrating three memory reads in a computer system according to a preferred embodiment of the present invention; and

FIG. 9 is a schematic block diagram of a VLIW-based computer system according to an exemplary embodiment of the present invention.

### DETAILED DESCRIPTION OF EMBODIMENTS OF THE INVENTION

Throughout the drawings, the same reference characters will be used for corresponding or similar elements.

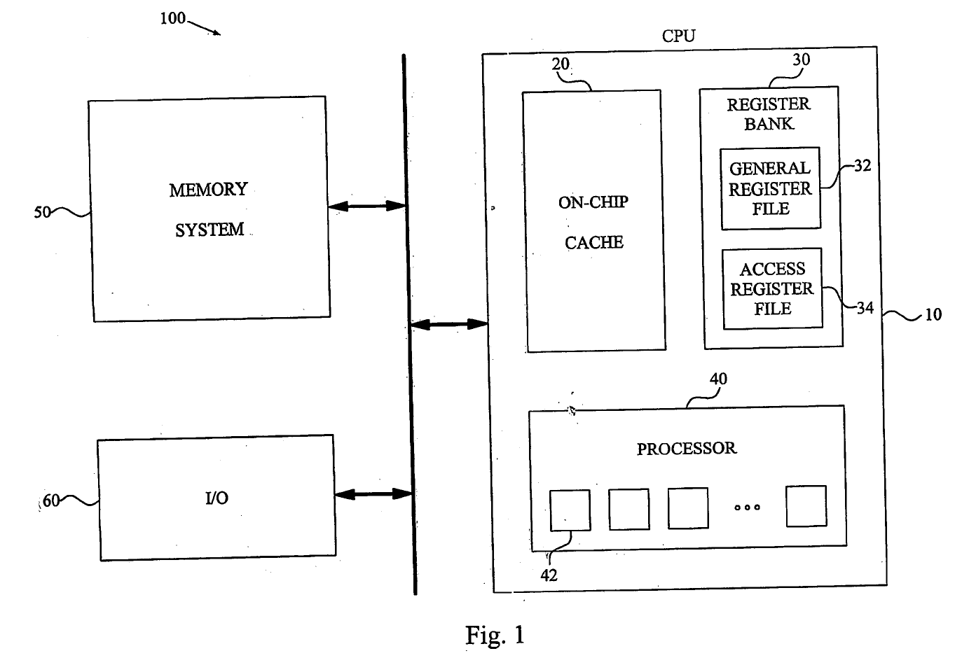

FIG. 1 is a schematic block diagram of an example of a computer system in which the present invention can be implemented. The system 100 basically comprises a central processing unit (CPU) 10, a memory system 50 and a conventional input/output (I/O) unit 60. The CPU 10 comprises an optional on-chip cache 20, a register bank 30 and a processor 40. The memory system 50 may have any general design known to the art. For example, the memory system 50 may be provided with a data store as well as a program store including operating system (OS) software, instructions and references. In the present invention, the register bank 30 includes a special-purpose register file 34 referred to as an access register file 34, together with other register files such as the general register file 32 of the CPU.

The general register file 32 typically includes a conventional program counter as well as registers for holding input operands required during execution. However, the information in the general register file 32 is preferably not related to memory address calculations. Instead, such memory address calculation information is kept in the special-purpose access register file 34, which is adapted for this type of information. The memory address calculation information is generally in the form of implicit or indirect memory access information such as memory reference information, address translation information or memory mapping information.

Implicit memory access information does not directly point out a location in the memory, but rather includes information necessary for determining the memory address of some data stored in the memory. For example, implicit memory access information may be an address to a memory location, which in turn contains the address of the requested data, i.e. the effective address, or yet another address to a memory location, which in turn contains the effective address. Another example of implicit memory access information is address translation information, or memory mapping information. Address translation or memory mapping are terms for mapping a virtual memory block, or page, to the physical main memory. A virtual memory is generally used for providing fast access to recently used data or recently used portions of program code. However, in order to access the data associated with an address in the virtual memory, the virtual address must first be translated into a physical address. The physical address is then used to access the main memory.

The processor 40 may be any processor known to the art, as long as it has processing capabilities that enable execution of instructions. In the computer system 100 according to the exemplary embodiment of FIG. 1, the processor includes one or more functional execution units 42 operable for determining memory addresses in response to memory address calculation information received from the access register file 34. The functional unit or units 42 utilizes a set of operations to perform the address calculations based on the received address calculation information. The actual memory accesses may be performed by the same functional unit(s) 42 or another functional unit or set of functional units. It is thus possible to use a single functional unit to determine a memory address and to effectuate the corresponding memory access. Depending on the load sharing between functional units in the processor, it may be more beneficial to use a functional unit for determining the address and another functional unit for the actual memory access. If the address determination is more complex, it may be useful to distribute the task of determining the address among several functional units in the processor.

For efficient transfer of memory address calculation information in relation to the access register file 34, one or more dedicated data paths are used for loading the access register file 34 from memory and/or for transferring the information from the access register file 34 to the functional unit or units 42 in the processor. By having a system of dedicated data paths to and/or from the access register file 34, the memory address calculation information may be transferred in parallel with other data being transferred to and/or from the general register file 32. For example, this means that the access register file 34 may load address calculation information at the same time as the general register file 32 loads other data, thereby increasing the overall efficiency of the system.

The access register file 34 and the dedicated data paths do not have to use the same width as other data paths in the computer system. The memory address calculation information is often wider than other data transferred in the computer system, and would therefore normally require multiple operations or multi-cycle operations for loading, using conventional data paths. For this reason, the access register file and its dedicated data path or paths are preferably adapted in width to allow efficient single-cycle transfer of the information. Such adaptation normally means that a data path may transfer the necessary memory address calculation information, which may constitute several wards, in a single clock cycle.

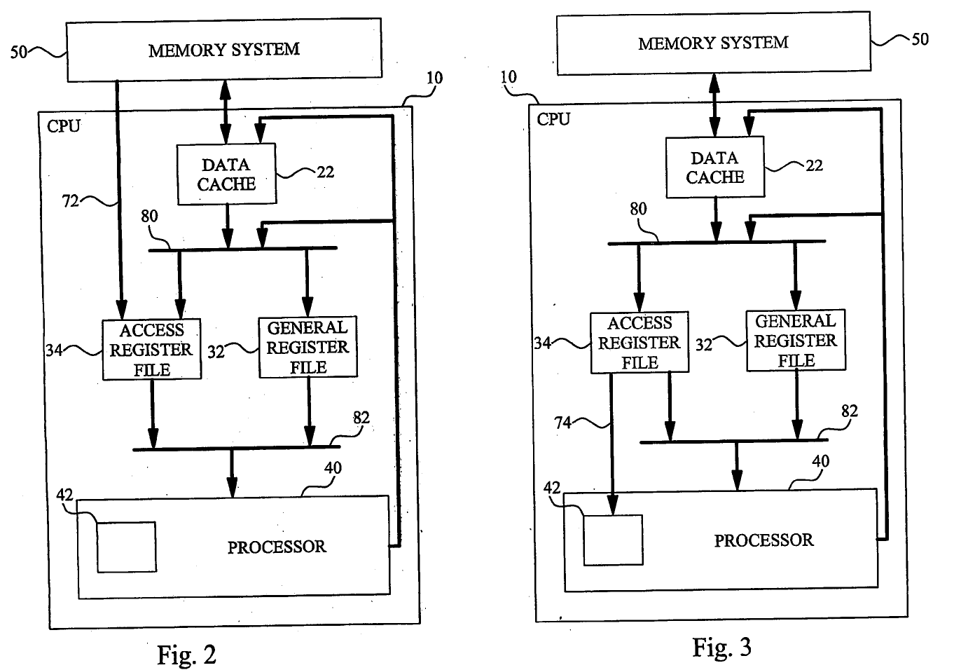

FIGS. 2 to 5 illustrate various embodiments according to the present invention with different possible arrangements of dedicated data paths.

In the system of FIG. 2, a dedicated data path 72 is arranged between a memory system 50 and an access register file 34. This dedicated data path 72 is used for loading memory access information from the memory system 50 to the access register file 34. By using the dedicated data path 72 for transferring memory access information, the load on the data cache 22, the bus 80 and the general register file 32 will be reduced. In addition to the dedicated data path 72, data may be transferred from the memory system 50 to the register files 32, 34 via a data cache 22 and an optional data bus 80. This cache 22 and data bus 80 primarily handles other data than memory access information, but may also transfer memory access information between the memory system 50 and the access register file 34 if desired. The information stored in the register files 32, 34 is transferred to a processor 40, preferably by using a further data bus 82. At least one dedicated functional unit 42 is arranged in the processor 40 for determining memory addresses in response to memory access information received from the access register file 34. Once a memory address is determined, the corresponding memory access (read or write) may be effectuated by the same or another functional unit in the processor. As in many modern microprocessors, the processor 40 performs write-back of execution results to the data cache 22 and/or to the register files 32, 34. As reads to the main memory are issued in the computer system, the system first goes to the cache to determine if the information is present in the cache. If the information is available in the cache, a so-called cache hit, access to the main memory is not required and the required information is taken directly from the cache. If the information is not available in the cache, a so-called cache miss, the data is fetched from the main memory into the cache, possibly overwriting other active data in the cache. Similarly, as writes to the main memory are issued, data is written to the cache and copied back to the main memory.

FIG. 3 illustrates another possible arrangement according to the present invention. Here a dedicated data path 74 is present between the access register file 34 and at least one dedicated functional unit 42 in the processor 40. This data path 74 allows fast and efficient transfer of the memory access information from the access register file 34 to the functional unit 42. The functional unit 42 determines memory addresses in response to the memory access information and may effectuate the corresponding memory accesses. If desired, the memory access information may be transferred from the access register file 34 to the functional unit 42 through the data bus 82. Usually, however, memory access information is transferred over the dedicated path 74 in parallel with other data being transferred from the general register file 32 to the processor 40. This naturally increases the overall system efficiency. In the particular embodiment of FIG. 3, both the access register file 34 and the general register file 32 are loaded from the memory system 50 through the data cache 22 and the optional data bus 80.

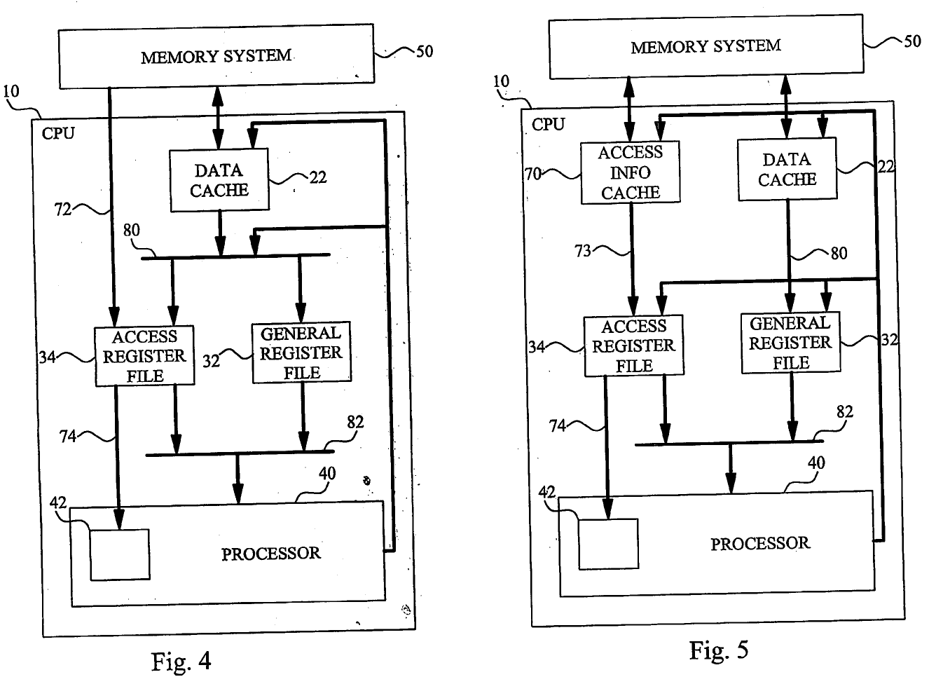

FIG. 4 illustrates an embodiment based on a combination of the two dedicated data paths of FIGS. 2 and 3. Here, dedicated data paths 72, 74 for transferring memory access information are arranged both between the memory system 50 and the access register file 34 and between the access register file 34 and the functional unit(s) 42. This results in efficient transfer of memory access information from the memory system 50 to the access register file 34 as well as efficient transfer of the information from the access register file 34 to the relevant functional unit or units 42 in the processor.

As illustrated in FIG. 5, it is possible to introduce a special dedicated cache for memory access information in order to benefit from the advantages of cache memories also for this type of information, and thus reduce the overall load time. Accordingly, a dedicated cache 70 may be connected between the memory system 50 and the access register file 34 with a dedicated data path 73 directly from the cache 70 to the access register file 34. The cache 70, which is referred to as an access information cache, is preferably adapted for the memory access information such that the size of the cache words is adjusted to fit the memory access information size.

The particular design of the computer system in which the invention is implemented may vary depending on the design requirements and the architecture selected by the system designer. For example, the system does not necessarily have to use a cache such as the data cache 22. On the other hand, the overall memory hierarchy may alternatively have two or more levels of cache. Also, the actual number of functional processor units 42 in the processor 40 may vary depending on the system requirements. Under certain circumstances, a single functional unit 42 may be sufficient to perform the memory address calculations and effectuate the corresponding memory accesses based on the information from the access register file 34. However, for systems supporting dynamic linking and/or when emulating an instruction set onto another instruction set, it may be more beneficial to use several functional units 42 dedicated for memory address calculations and memory accesses, respectively. It is also be possible that some of the functional units 42 may handle both memory calculations and memory accesses, possibly together with other functions.

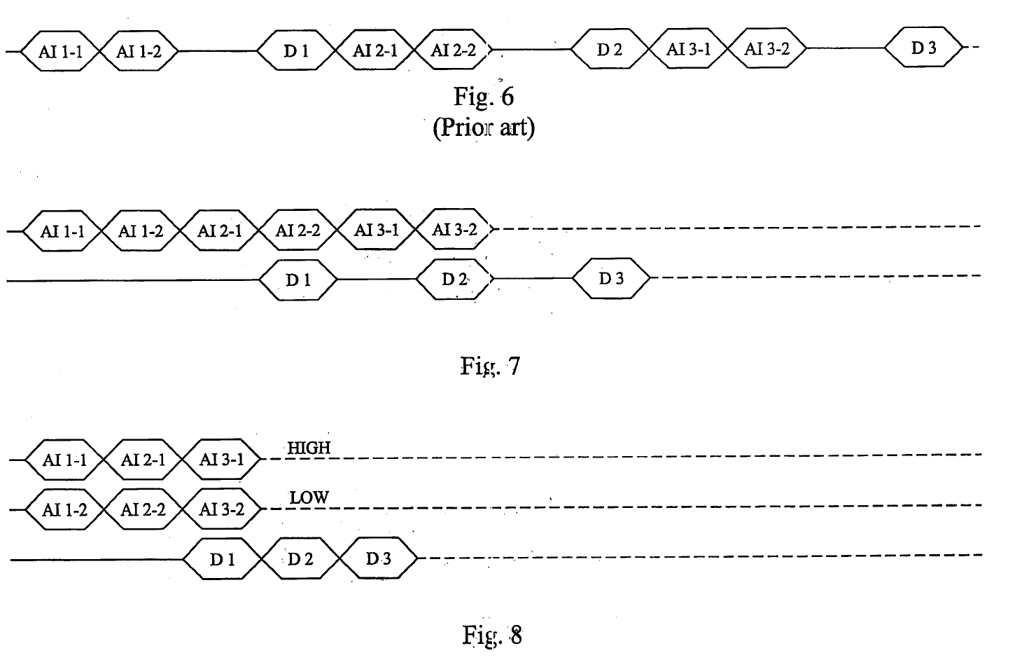

For a better understanding of the advantages offered by the present invention, a comparison of the memory access bandwidth obtained in a prior art computer system and the memory access bandwidth obtained by using the invention will now be described with reference to FIGS. 6-8.

In the following examples, the memory access bandwidth, also referred to as fetch bandwidth, is represented by the number of clock cycles, during which input ports are occupied when data is read from the memory hierarchy (including on-chip caches). It is furthermore assumed that the memory address calculation information for a single memory access comprises two words and that the data to be accessed from the determined memory address is one word. It is also assumed that the calculation of the memory address takes one clock cycle. The assumptions above are only used as examples for illustrative purposes. The actual length of the memory address calculation information and the corresponding data, as well as the number of clock cycles required for calculating a memory address may differ from system to system.

FIG. 6 illustrates three memory reads in a prior art computer system with a common data cache, but without a dedicated access register file. In such a computer system, the general register file have to handle both the memory address calculation information as well as other data. In a first clock cycle, a first word AI 1-1 of memory access information (AI 1: AI 1-1, AI 1-2) related to a first memory read is fetched from the data cache using the ordinary data bus. In the next clock cycle, the second word AI 1-2 of the relevant access information is fetched. Next, the corresponding memory address is determined based on the access information words. Once the memory address has been determined, a first data D1 can be read in the following clock cycle. Thus, the first memory read occupies the data cache port for three clock cycles. The total time required to read the first data D1 is of course four clock cycles. The actual address calculation, however, does not involve any reads, and this clock cycle could theoretically be used for reading data to another instruction. Similarly, the second memory read occupies the data cache port for three clock cycles, two cycles for reading the relevant access information (AI 2: AI 2-1, AI 2-2) and one cycle for reading the actual data (D2). In the same way, the third memory read occupies the data cache port for three clock cycles, two cycles for reading the relevant access information (AI 3: AI 3-1, AI 3-2) and one cycle for reading the actual data (D3).

FIG. 7 illustrates the same three memory reads in a computer system according to an embodiment of the invention. This computer system has a dedicated access register file or holding memory address calculation information, and preferably also a dedicated access information cache connected to the access register file. This means that access information words may be read into the access register file at the same time as data words of previous, memory reads are read from the memory. Starting with first memory read, a first word AI 1-1 and second word AI 1-2 of the memory access information is read by the access register file. This information is forwarded to the functional unit(s) of the processor for determining the corresponding memory address. During this clock cycle of memory address calculations, a first word AI 2-1 of the memory access information related to a second memory read is read into the access register file. In the next clock cycle, memory address of the first memory read is ready and a first data word D1 may be read. At the same time as the data word D1 is read, the access register file reads the second memory access information word AI 2-2 of the second memory read. In the next clock cycle, at the same time as the memory address of the second memory read is determined, the first word AI 3-1 of the access information of the third memory read is read into the access register file. As the second data word D2 is read, the second word AI 3-2 of the access information of the third memory read is read into the access register file. Finally, in the next clock cycle, the third data word D3 is read from the memory. It can be seen that each time the access register file reads a second word of memory access information, a data word of a previous memory read is read concurrently from the cache, which results in an increase in the effective memory access bandwidth.

FIG. 8 illustrates the same three memory reads in a computer system according to another embodiment of the invention. This computer system not only has a dedicated access register file and optional access information cache, but also data paths adapted in width for transferring the memory access information in the system. The width-adapted data paths allow all memory access information, i.e. both the first and second word, to be read in a single clock cycle. Thus, in the first clock cycle, both the first word AI 1-1 and second word AI 1-2 of memory access information are read from the access information cache into the access register file using a wide interconnect (shown as ‘high’ and ‘low’ bus branches). The second clock cycle is used for reading a first word AI 2-1 and second word AI 2-2 of the memory access information of a second memory read, as well as for determining the memory address of the first memory read. In the next clock cycle, the data word D1 of the first memory read is accessed. At the same time, the access information words AI 3-1, AI 3-2 of the third memory read are read from the access information cache to the access register file, and the memory address of the second memory read is determined. Subsequently, the data word D2 of the second memory read is accessed, and the memory address of the third memory read is determined. Finally, the data word D3 of the third memory read can be accessed. Consequently, a memory read now occupies the wider access information cache port in one clock cycle and the data cache port in another clock cycle. By pipelining memory accesses, this approach enables one memory read per clock cycle and memory port. This represents a significant increase of the effective memory access bandwidth, compared to prior art systems.

The present invention is particularly advantageous in computer systems handling large amounts of memory address calculation information, including systems emulating another instruction set or systems supporting dynamic linking (late binding).

For example, when emulating a complex CISC instruction set on a RISC or VLIW processor, the complex CISC operations can not be directly mapped to a corresponding RISC instruction or to an operation in a VLIW instruction. Instead, each complex memory operation is mapped into a sequence of instructions that in turn performs e.g. memory address calculations, memory mapping and checks. In conventional computer systems, the emulation of the complex memory operations generally becomes a major bottleneck.

The invention will now be described with reference to an example of VLIW-based implementation suitable for emulating a complex CISC instruction set. In general, VLIW-based processors ty to exploit instruction-level parallelism, and the main objective is to eliminate the complex hardware-implemented instruction scheduling and parallel dispatch used in modern superscalar processors. In the VLIW approach, scheduling and parallel dispatch are performed by using a special compiler, which parallelizes instructions at compilation of the program code.

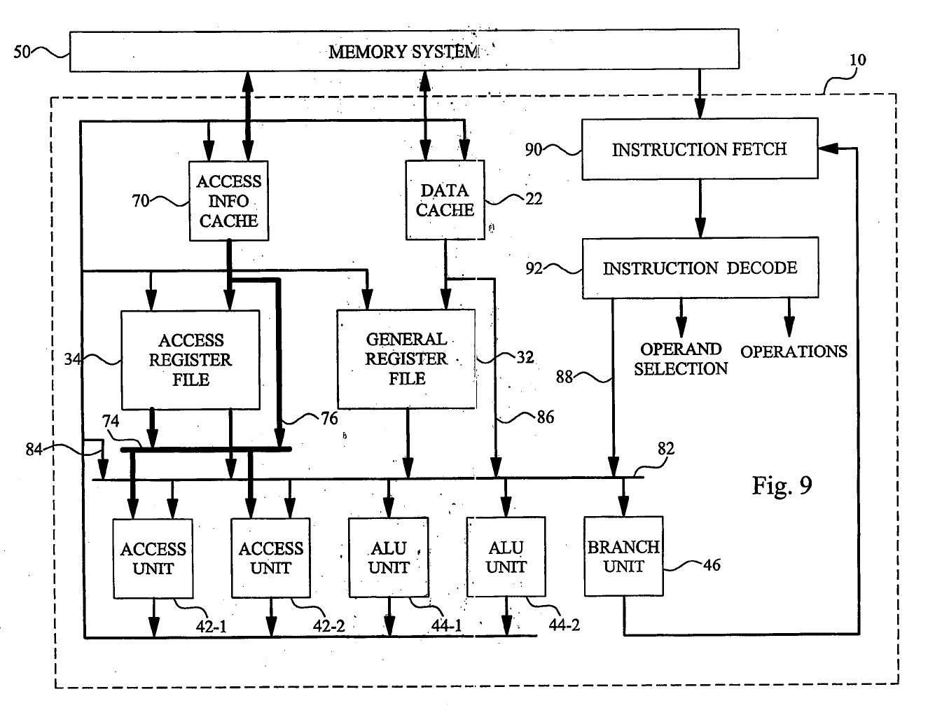

FIG. 9 is a schematic block diagram of a VLIW-based computer system according to an exemplary embodiment of the present invention. The exemplary computer system basically comprises a VLIW-based CPU 10 and a memory system 50. In this particular embodiment, the VLIW-based CPU 10 is built around a six-stage pipeline: Instruction Fetch, Instruction Decode, Operand Fetch, Execute, Cache Access and Write-Back. The pipeline includes an instruction fetch unit 90, an instruction decode unit 92 together with additional functional execution and branch units 42-1, 42-2, 44-1, 44-2 and 46. The CPU 10 also comprises a conventional data cache 22 and a general register file 32. The system is primarily characterized by an access information cache 70, an access register file 34 and functional access units 42-1, 42-2 interconnected by dedicated data paths. The access information cache 70 and the access register file 34 are preferably dedicated to hold only memory access information and thus normally adapted to the access information size. By using separate data paths adapted in width to memory access information, it is possible to transfer memory access information that is wider than other normal data without introducing multi-cycle transfers.

In operation, the instruction fetch unit 90 fetches a VLIW word, normally containing several primitive instructions, from the memory system 50. In addition to normally occurring instructions, the VLIW instructions preferably also include special-purpose instructions adapted for the present invention, such as instructions for loading the access register file 34 and for determining memory addresses based on memory access information stored in the access register file 34. The fetched instructions whether general or special are decoded in the instruction decode unit 92. Operands to be used during execution are typically fetched from the register files 32, 34, or taken as immediate values 88 derived from the decoded instruction words. Operands concerning memory address determination calculation and memory accesses are found in the access register file 34 and other general operands are found in the general register file 32. Functional execution units 42-1, 42-2; 44-1, 44-2 execute the VLIW instructions more or less in parallel. In this particular example, there are functional access units 42-1, 42-2 for determining memory addresses and effectuating the corresponding memory accesses by executing the decoded special instructions. Preferably, the ALU units 44-1, 44-2 execute special-purpose instructions for reading access information from the access information cache 70 into the access register file 34. The reason for letting the ALU units execute these read instructions is typically that a better instruction load distribution among the functional execution units of the VLIW processor is obtained. The instructions for reading access information to the access register file 34 could equally well be executed by the access units 42-1, 42-2. Execution results can be written back to the data cache 22 (and copied back to the memory system 50) using a write-back bus. Execution results can also be written back to the access information cache 70, or to the register files 32, 34 using the write-back bus.

In order to streamline the transfer of data in the computer system of FIG. 9, forwarding paths 76, 84, 86 may be introduced. This is useful when the instructions for handling the memory access information are similar to the basic instructions for integers and floating points, i.e. load instructions for loading data to the access register file 34 and register-register instructions for processing the memory access information. A forwarding path 84 may be arranged from the write-back bus to operand bus 82 leading to the functional units 42-1, 42-2, 44-1, 44-2, 46. Such a forwarding path 84 makes it possible to use the output from one register-register instruction directly in the next register-register instruction without passing the data via the register files 32, 34. In addition, a forwarding path 86 may be arranged from the general data cache 22 to the operand bus 82 and the functional units 42-1, 42-2; 44-1, 44-2. With such an arrangement the one clock cycle penalty of writing the data to the general register file 32 and reading it therefrom in the next clock cycle is avoided. In a similar way, a wider forwarding path 76 may be arranged for forwarding access information directly from the dedicated cache 70 to the dedicated functional units 42-1, 42-2.

For a more thorough understanding of the operation and performance of the VLIW-based computer system of FIG. 9, a translation of an exemplary sequence of ASA instructions into primitive instructions (primitives), and scheduling of the primitives for parallel execution by the VLIW processor will now be described. The example is related to the APZ machine from Ericsson.

Table I below lists an exemplary sequence of ASA instructions. The instruction set supports dynamic linking. A logical variable is read from a logical data store using a RS (read store) instruction that implicitly accesses linking information and calculates the physical address in memory.

TABLE I

| Execution cycle | Instruction | | Comment |
|---|---|---|---|
| 00580032 | RSA | DR0- 3; | : read logical variable no 3 to register DR0 |
| 00580033 | JEC | DR0, 1, %L%392C; | : jump if DR0 equal to 1 to label |
| 00580048 | RSU | DR0- 75; | : load unsigned logical variable 75 to DR0 |
| 00580048 | LHC | CR/W0-20; | : load 20 to register CR/W0 |
| 00580049 | JER | DR0, %L%3938; | : jump if register is 0 to label |
| 00580049 | LHC | GR/W0-21; | : load 21 to register GR/W0 |
| 00580050 | JER | DR0, %L%393E; | : jump if register is 0 to label |
| 00580065 | RSU | DR0- 159; | : read logical variable no 159 to register DR0 |
| 00580066 | JUC | DR0, 1, %L%3A6C; | : jump if DR0 unequal to 1 to label |
| 00580067 | WZU | 11; | : write zero to logical variable no 11 |
| 00580068 | WZU | 12; | : write zero to logical variable no 12 |
| 00580079 | RSA | DR0- 1; | : read logical variable no 1 to register DR0 |
| 00580080 | JUC | DR0, 2, %L%40E9; | : jump if DR0 unequal to 2 to label |
| 00580081 | WHCU | 1- 3; | : write 3 to logical variable no 1 |
| 00580082 | JLN | %L%40E9; | : jump to label |
| 00580082 | MFR | PR0- WR18; | : move from register to register |
| 00580083 | WZU | 11; | : write zero to logical variable no 11 |
| 00580084 | WZU | 12; | : write zero to logical variable no 12 |
| 00580084 | LCC | DR0- 0; | : load 0 to register DR0 |
| 00580085 | WSSU | 71/B7-DR0; | : write bit7 in var71 with value in DR0. |
| 00580115 | RSA | DR0- 1; | : read logical variable no 1 to register DR0 |
| 00580116 | JUC | DR0, 1, %L%40F6; | : jump if DR0 un equal to 1 to label |
| 00580117 | WZL | 426; | : write zero to logical variable no 426 |
| 00580117 | RSA | DR0- 28; | : read logical variable no 3 to register DR0 |
| 00580118 | LWCD | CR/D0-65535; | : load 65535 to register CR/D0 |
| 00580119 | JUR | DR0, %L%4105; | : jump if DR0 equal to 0 to label |
| 00580120 | WSA | 28-WR18; | : write register contents to logical variable 28 |
| 00580121 | WSU | 82-WR18; | : write register contents to logical variable 82 |
| 00580122 | WOU | 63; | : write all ones to logical variable 63 |
| 00580123 | WHCU | 29-1; | : write 1 to logical variable no 29 |
| 00580124 | JLN | %L%410F; | : jump to label |

As illustrated in table II below, the ASA sequence may be translated into primitives for execution on the VLIW-based computer system. In an exemplary embodiment of the invention, APZ registers such as PRO, DRx, WRx and CR/W0 are mapped to VLIW general registers, denoted grxxx below. The VLIW processor generally has many more registers, and therefore, the translation also includes register renaming to handle anti-dependencies, for example as described in Computer Architecture: A Quantitative Approach by J. L. Hennessy and D. A. Patterson, second edition 1996, pp. 210-240, Morgan Kaufmann Publishers, California. The compiler performs register renaming and, in this example, each write to an APZ register assigns a new grxx register in the VLIW architecture. Registers in the access register file, denoted arxxx below, are used for address calculations performing dynamic linking that are implicit in the original assembler code. A read store, RSA in the assembler code above, is mapped to a sequence of instructions: LBD (load linkage information), ACVLN (address calculation variable length), ACP (address calculation pointer), ACI (address calculation index), and LD (load data). The example assigns a new register in the ARF for each step in the calculation when it is updated. A write store performs the same sequence for the address calculation and then the last primitive is an SD (store data) instead of LD (load data).

The memory access information is loaded into the access register file 34 by a special-purpose instruction LBD. The LBD instruction uses a register in the access register file 34 as target register instead of a register in the general register file 32. The information in the access register file 34 is transferred via a dedicated wide data path, including a wide data bus 74, to the functional access units 42-1, 42-2. These functional units 42-1, 42-2 perform the memory address calculation in steps by using special instructions ACP and ACVLN, and finally effectuates the corresponding memory accesses by using a load instruction LD or a store instruction SD.

Redundant primitives are revealed when complex instructions are broken up into primitives, and normally removed. When the address calculation is made explicit in this way it is possible for the code optimizer to remove unnecessary steps, for example ACI and ACP is only needed for one and two dimensional array variables and ACVLN is not needed for normal 16-bit variables. Also, it is not necessary to redo the address calculations, or parts of it, when having multiple accesses to the same variable.

TABLE II

| | | |
|---|---|---|
| . . . | | |
| ACP | ar99, PR0 -> ar104 | : ar104.addr: = pr0*2\hat{ }(ar99.v + ar99.q) |
| SD | gr50 -> (ar104) | : store data in gr50 in ar104 address |
| ACP | ar101, PR0 -> ar105 | : calc. addr. from values in ar101 |
| SD | gr50 -> (ar105) | : store data in gr50 at ar105.addr |
| ACVLN | ar73, B7 -> ar106 | : calc. (add) var. length part of addr. |
| SD | DR0 -> (ar106) | : store DR0 value at resulting address |
| ACP | ar2, PR0 -> ar107 | : calculate pointer part of var. address |
| LD | (ar107) -> DR0 | : load register DR0 from addr. in ar107. |
| CMPC | DR0,#1 -> p28 | : compare equality with constant |
| LIR | #1 -> gr71 | : load immediate to register |
| LBD | 42 -> ar108 | : load addr. calc data (v & q) into ar108 |
| ACP | ar108,PR0 -> ar109 | : calculate pointer part of address |
| SEL | p28,gr71, | : select depending on pxx |
| | gr50 -> gr72 | |
| SD | gr72 -> (ar109) | : store data in gr72 at address in ar109 |
| LBD | 28 -> ar110 | : load address calc. data into ar110 |
| LD | (ar110) -> DR0 | : load data from address in ar110 |
| CMPC | DR0,#65535 -> p29 | : compare equality with constant |
| CJMPI | p29, ... | : conditional jump if pxx not true |
| SD | WR18 -> (ar110) | : store data |
| LBD | 82 -> ar111 | : load address data from table (idx: 82) |
| SD | WR18 -> (ar111) | : store data |
| LBD_{c} | 63 -> ar112 | : load address data, table index is 63 |
| ACP | ar112,PR0 -> ar113 | : calculate addres with pointer in PR0 |
| LIR | #−1 -> gr76 | : load immediate to register |
| SD | gr76 -> (ar113) | : store data from gr76 to ar113.addr |
| LBD | 29 -> ar114 | : load address data (ar114.v, ar114.q). |
| LIR | #1 -> gr78 | : load immediate to register |
| SD | gr78 -> (ar114) | : store data in gr78 at ar114.addr |
| JL | . . . | : jump to label |

These primitives can be scheduled for parallel execution on the VLIW system of FIG. 9 as illustrated in Table III below:

TABLE III

| Access Unit 1 | Access Unit 2 | ALU 1 | ALU 2 | Branch Unit |
|---|---|---|---|---|
| ACP ar99, PR0->ar104 | LD (ar107)->DR0 | LBD 28->ar110 | LBD 426->ar108 | |
| SD gr50->(ar104) | ACVLN ar73, B7->ar106 | LBD 63-> ar112 | LBD 82 -> ar111 | |
| ACP ar101, PR0->ar105 | SD DR0->(ar106) | CMPC DR0,#1->p28 | LIR #1 -> gr71 | |
| LD (ar110)->DR0 | ACP ar108,PR0->ar109 | SEL p28,gr71,gr50->gr72 | LBD 29->ar114 | |
| SD gr50 -> (ar105) | SD gr72->(ar109) | LBD 434->ar115 | LIR #−1->gr76 | |
| ACP ar112,PR0->ar113 | | CMPC DR0,#65535->p29 | LIR #1->gr78 | |
| SD p29,WR18->(ar110) | SD p29,WR18->(ar111) | | | CJMPI p29, . . . |
| SD gr76->(ar113) | SD gr78->(ar114) | | | JL . . . |

The example above assumes a two-cycle load-use latency (one delay slot) for accesses both from the access information cache and from the data cache, and can thus be executed in eight clock cycles if there are no cache misses.

The advantage of the invention is apparent from the first line of code (in Table III), which includes three separate loads, two from the access information cache 70 and one from the data cache 22. The memory access information is two words long in the example, which means that 5 words of information is loaded in one clock cycle. In the prior art, this would normally require 3 clock cycles, even when implementing a dual-ported cache.

It can be noted that separate “address registers” or “segment registers” are used in many older processor architectures such as Intel IA32 (×86 processor), IBM Power and HP PA-RISC. However, these registers are usually used for holding an address extension that is concatenated with an offset for generating an address that is wider than the word length of the processor (for example generating a 24 bit or 32 bit address on a 16 bit processor). These address registers are not related to step-wise memory address calculations, nor supported by a separate cache and dedicated load path.

In the article HP, Intel Complete IA64 Rollout, by K. Diefendorff, Microprocessor Report, Apr. 10, 2000, a VLIW architecture with separate “region registers” is proposed. These registers are not directly loaded from memory and there are no special instructions for address calculations. The registers are simply used by the address calculation hardware as part of the execution of memory access instructions.

The VLIW-based computer system of FIG. 9 is merely an example of a possible computer system suitable for emulation of a CISC instruction set. The actual implementation may differ from application to application. For example, additional register files such as a floating point register file and/or graphics/multimedia register files may be employed. Likewise, the number of functional execution units may be varied within the scope of the invention. It is also possible to realize a corresponding implementation on a RISC computer.

The invention is particularly useful in systems using dynamic linking, where the memory addresses of instructions and/or variables are determined in several steps based on indirect or implicit memory access information. In systems with dynamically linked code that can be reconfigured during operation, the memory addresses are generally determined by means of look-ups in different tables. The initial memory address information itself does not directly point to the instruction or variable of interest, but rather contains a pointer to a look-up table or similar memory structure, which may hold the target address. If several table look-ups are required, a lot of memory address calculation information must be read and processed before the target address can be retrieved and the corresponding data accessed. By implementing any combination of a dedicated access information cache, a dedicated access register file and functional units adapted to perform the necessary table look-ups and memory address calculations, the memory access bandwidth and overall performance of computer systems using dynamic linking will be significantly improved.

Although the improvement in performance obtained by using the invention is particularly apparent in applications involving emulation of another instruction set and dynamic linking, it should be understood that the computer design proposed by the invention is generally applicable.

The clock frequency of any chip implemented in deep sub-micron technology (0.15 μm or smaller) is limited by the delays in the interconnecting paths. Interconnect delays are minimized with a small number of memory loads and by keeping wiring short. The use of a dedicated access register file and a dedicated access information cache makes it possible to target both ways of minimizing the delays. The access register file with its dedicated load path gives a minimal number of memory loads. If used, the access information cache can be co-located with the access register file on the chip, thus reducing the required wiring distance. This is quite important since modern microprocessors have the most timing critical paths in connection with first level cache accesses.

The embodiments described above are merely given as examples, and it should be understood that the present invention is not limited thereto. Further modifications, changes and improvements which retain the basic underlying principles disclosed and claimed herein are within the scope and spirit of the invention.

1. A computer system comprising:
a special-purpose register file adapted for holding memory address calculation information received from memory, said special-purpose register file having at least one dedicated interface for allowing efficient transfer of memory address calculation information in relation to said special-purpose register file;
means for determining a memory address in response to memory address calculation information received from said special-purpose register file, thus enabling a corresponding memory access.

2. The computer system according to claim 1, further comprising means for effectuating a memory access based on the determined memory address.

3. The computer system according to claim 1, wherein said at least one dedicated interface comprises a dedicated interface between said special-purpose register file and memory.

4. The computer system according to claim 1, wherein said at least one dedicated interface comprises a dedicated interface between said special-purpose register file and said means for determining a memory address.

5. The computer system according to claim 1, wherein said at least one dedicated interface includes a dedicated data path adapted in width to said memory address calculation information.

6. The computer system according to claim 1, wherein said memory comprises a dedicated cache adapted for said memory address calculation information.

7. The computer system according to claim 1, wherein said means for determining a memory address comprises at least one functional processor unit.

8. The computer system according to claim 7, wherein a forwarding data path is arranged from an output bus associated with said at least one functional processor unit to an input bus associated with said at least one functional processor unit.

9. The computer system according to claim 1, wherein said means for determining a memory address is operable for executing special-purpose instructions in order to determine said memory address.

10. The computer system according to claim 1, further comprising means for executing special-purpose load instructions in order to load said memory address calculation information from said memory to said special-purpose register file.

11. The computer system according to claim 10, wherein said means for executing special-purpose load instructions comprises at least one functional processor unit.

12. The computer system according to claim 11, wherein a forwarding data path is arranged from said memory to an input wherein said memory address calculation information is in the form of implicit memory access information.

14. The computer system according to claim 13, wherein said implicit memory access information includes memory address translation information.

15. A computer system comprising:
a dedicated cache adapted for holding memory access information;
a special-purpose register file adapted for holding memory access information received from said dedicated cache over a first dedicated interface;
means for determining a memory address in response to memory access information received from said special-purpose register file over a second dedicated interface; and
means for effectuating a corresponding memory access based on the determined memory address.

16. The computer system according to claim 15, wherein said first and second dedicated interfaces are adapted in width to said memory address calculation information.

17. A method of handling memory address calculation information, said method comprising the steps of:
holding memory address calculation information received from memory, in a special purpose register file,
transferring memory address calculation information in relation to said special-purpose register file via at least one dedicated interface associated with said special purpose register file; and
determining a memory address in response to memory address calculation information received from said special-purpose register file, thus enabling a corresponding memory access.

18. The method according to claim 17, further comprising the step of
effectuating a memory access based on the determined memory address.

19. The method according to claim 17, wherein said at least one dedicated interface comprises a dedicated interface between said special-purpose register file and memory.

20. The method according to claim 17, wherein said at least one dedicated interface comprises a dedicated interface between said special-purpose register file and so a means for determining a memory address.

21. The method according to claim 17, further comprising the step of
adapting a dedicated data path in width to said memory address calculation information.

22. The method according to claim 17, further comprising the step of
utilizing a dedicated cache adapted for said memory address calculation information.
